(19) United States
(12) Patent Application Publication
(10) Pub. No.: US 2021/0075542 A1
(43) Pub. Date: Mar. 11, 2021

(54) PHY-BASED HYBRID AUTOMATIC REPEAT REQUEST (HARQ)

(71) Applicant: Apple Inc., Cupertino, CA (US)

(72) Inventors: Jarkko L. KNECKT, Los Gatos, CA (US); Yong LIU, Campbell, CA (US); Jinjing JIANG, San Jose, CA (US); Su Khiong YONG, Palo Alto, CA (US); Tianyu WU, Cupertino, CA (US)

(73) Assignee: Apple Inc., Cupertino, CA (US)

(21) Appl. No.: 17/012,877

(22) Filed: Sep. 4, 2020

Related U.S. Application Data
(60) Provisional application No. 62/896,423, filed on Sep. 5, 2019.

(51) Int. Cl. H04L 1/00; H04L 1/18; H04W 80/02; H04L 1/16

(52) U.S. Cl. CPC H04L 1/0061; H04L 1/1614; H04W 80/02; H04L 1/1819

(57) ABSTRACT

Some embodiments of this disclosure include apparatuses and methods for a PHY level operation that enables a transmitter and a receiver to select low-density parity check (LDPC) codewords that are HARQ retransmitted. The operations described herein provide for an increased reliability in detecting codewords at the physical (PHY) layer, as the codeword detection does not depend on detection of a media access control (MAC) protocol data unit (MPDU) start position and length. For example, the PHY layer may store failed codewords without instructions from the MAC layer. This providers for faster and simpler implementation of the PHY layer. Additionally, the operations described herein reduce overhead requirements as the MAC layer may stores a bit stream of correctly received codewords, which requires less the storage space required to store failed codewords. Furthermore, a feedback signal transmitted from a receiving device to a transmitting device may further reduce the number of retransmitted codewords.

### CROSS-REFERENCE TO RELATED APPLICATIONS AND INCORPORATION BY REFERENCE

This application claims priority to U.S. Provisional Application No. 62/896,423, filed Sep. 5, 2019, and entitled “PHY-Based Hybrid automatic repeat request (HARQ),” the content of which is hereby incorporated by reference in its entirety.

### BACKGROUND

### Field

The described embodiments generally relate to wirelessly transmitting data packets.

For example, the embodiments of this disclosure relate to formatting data packets for transmission and retransmission.

### Related Art

Hybrid automatic repeat request (HARQ) is a combination of high-rate forward error-correcting coding and ARQ error-control. In HARQ, a receiver receives low-density parity-check (LDPC) codewords (CWs), parses the content, and stores any failed CWs. The receiver then indicates to the transmitter which CWs were incorrectly received, and in response, the transmitter retransmits the failed CWs or additional LDPC encoding to the failed CWs back to the receiver. The receiver may then process the retransmitted CWs along with the stored failed CWs to verify whether the retransmitted CWs were correctly received. The retransmissions may continue until the codeword is received correctly or the maximum number of HARQ retransmissions is met.

### SUMMARY

Some embodiments of this disclosure include apparatuses and methods for a PHY level operation that enables a transmitter and a receiver to select low-density parity check (LDPC) codewords that are HARQ retransmitted. The operations described herein provide for an increased reliability in detecting codewords at the physical (PHY) layer, as the codeword detection does not depend on detection of a media access control (MAC) protocol data unit (MPDU) start position and length. For example, the PHY layer may store failed codewords without instructions from the MAC layer. This providers for faster and simpler implementation of the PHY layer. Additionally, the operations described herein reduce overhead requirements as the MAC layer may stores a bit stream of correctly received codewords, which requires less the storage space required to store failed codewords. Furthermore, a feedback signal transmitted from a receiving device to a transmitting device may further reduce the number of retransmitted codewords.

Some embodiments relate to a transmitting device. The transmitting device includes a transceiver configured to communicate over a wireless network and one or more processors communicatively coupled to the transceiver. The one or more processors are configured to: transmit, via the transceiver and to a receiving device, a first data stream comprising a plurality of codewords that represent a plurality of data blocks and respective checksum values associated with respective ones of the plurality of data blocks; receive, via the transceiver and from the receiving device, a feedback signal indicating whether a transmission error is present in the first data stream; identify one or more codewords to be retransmitted based at least on the feedback signal; and transmit, via the transceiver and to the receiving device, a second data stream comprising the one or more codewords to be retransmitted.

Some embodiments relate to a receiving device. The receiving device includes a transceiver configured to communicate over a wireless network and one or more processors communicatively coupled to the transceiver. The one or more processors are configured to: receive, via the transceiver, a first data stream comprising a plurality of codewords that represent a plurality of data blocks and respective checksum values associated with respective ones of the plurality of data blocks; regenerate, at a physical (PHY) layer, the plurality of data blocks and the plurality of checksum values based on the plurality of codewords; calculate, at the PHY layer, a plurality of expected checksum values; compare, at the PHY layer, a respective one of the plurality of expected checksum values to a respective one of the received checksum values; when the expected checksum value and the received checksum value do not match, store, by the PHY layer, any codewords that carried data in a respective data block associated with the respective received checksum in a memory; determine, at a media access control (MAC) layer, whether any transmission failures occurred in the plurality of data blocks; and transmit, via the transceiver and to the transmitting device, a feedback signal indicating whether there were any transmission errors in the first data stream.

Some embodiments relate to a method comprising: receiving, via a transceiver of a receiving device, a first data stream comprising a plurality of data blocks to a receiving device, a plurality of checksum values associated with a respective one of the plurality of data blocks, and a plurality of codewords associated with the plurality of data blocks and checksum values; regenerating, at a physical (PHY) layer of the receiving device, the plurality of data blocks and the plurality of checksum values based on the plurality of codewords; calculating, at the PHY layer, a plurality of expected checksum values; comparing, at the PHY layer, a respective one of the plurality of expected checksum values to a respective one of the received checksum values; when the expected checksum value and the received checksum value do not match, storing, by the PHY layer, any codewords that carried data in a respective data block associated with the respective received checksum in a memory; determining, at a media access control (MAC) layer of the receiving device, whether any transmission failures occurred in the plurality of data blocks; and transmitting, via the transceiver and to a transmitting device, a feedback signal indicating whether there were any transmission errors in the first data stream.

This Summary is provided merely for purposes of illustrating some embodiments to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing a PHY-based HARQ, according to some embodiments of the disclosure.

FIG. 2 illustrates a block diagram of an example wireless system of an electronic device, according to some embodiments of the disclosure.

FIG. 3 illustrates example operations of communication between two electronic devices, according to some embodiments of the disclosure.

FIGS. 4-7 illustrate example frame field formats and associated codewords, according to some embodiments of the disclosure.

FIGS. 8 and 9 illustrate example methods for implementing a PHY-based HARQ, according to some embodiments of the disclosure.

FIG. 10 is an example computer system for implementing some embodiments or portion(s) thereof.

FIG. 11 illustrates an example method for implementing a PHY-based HARQ, according to some embodiments of the disclosure.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some embodiments of this disclosure include apparatuses and methods for implementing a PHY-based HARQ. The PHY-based HARQ of this disclosure includes rules for defining when codewords should be retransmitted, formats for outgoing data streams to reduce the number of codewords to be retransmitted, and formats for a feedback signal for reducing the number of retransmission requests.

According to some embodiments, the PHY-based HARQ can be implemented with communication techniques compatible with Institute of Electrical and Electronics Engineers (IEEE) 802.11 standards (such as, but not limited to IEEE 802.11ac, IEEE 802.11ax, IEEE 802.11bc, IEEE 802.11bd, IEEE 802.11be, etc.). For example, the PHY-based HARQ can be used within a wireless local area Network (WLAN).

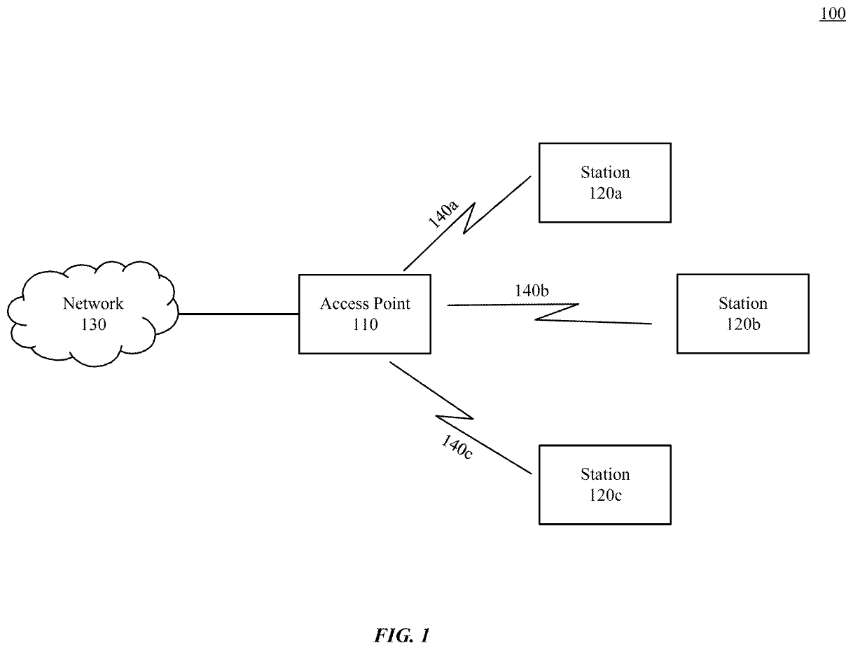

FIG. 1 illustrates an example system 100 implementing a PHY-based HARQ, according to some embodiments of the disclosure. Example system 100 is provided for the purpose of illustration only and does not limit the disclosed embodiments. System 100 may include, but is not limited to, an access point (AP) 110, a plurality of stations (STA) 120a-c (collectively referred to as stations 120), and a network 130. The stations 120 may include, but are not limited to, Wireless Local Area Network (WLAN) stations, such as wireless communication devices, smart phones, laptops, desktops, tablets, personal assistants, monitors, televisions, wearable devices, and the like. The access point (AP) 110 may include but is not limited to WLAN electronic devices such as a wireless router, a wearable device (e.g., a smart watch), a wireless communication device (e.g., a smart phone), or a combination thereof. The network 130 may be the Internet and/or a WLAN. The stations 120 communications are shown as wireless communications 140a-c (collectively referred to as communications 140). Communication between the AP 110 and the stations 120 may take place using the wireless communications 140. The wireless communications 140 may be based on a wide variety of wireless communication techniques. These techniques can include, but are not limited to, techniques based on IEEE 802.11, IEEE 802.11ac, IEEE 802.11ax, IEEE 802.11bc, IEEE 802.11bd, IEEE 802.11be, IEEE 802.11v, etc. standards.

According to some embodiments, the AP 110 and stations 120 may be configured to implement a PHY-based HARQ. The AP 110 may be configured to communicate with the stations 120 that the AP 110 is capable of using and implementing the PHY-based HARQ. Also, the AP 110 may be configured to communicate to stations 120 parameters and/or rules associated with the PHY-based HARQ. For example, the AP 110 can use a Beacon frame, an association response, a probe response frame, an information element (IE), a new management frame, and/or other frames to send the parameters and/or rules associated with the PHY-based HARQ to the stations 120. For example, the AP 110 may transmit an add block acknowledgement (ADDBA) request to setup a block acknowledgement that allows the AP 110 to send Physical Layer Convergence Procedure (PLCP) protocol data unit (PPDUs) with aggregated MAC protocol data unit (MPDU) (A-MPDUs). The stations 120 may respond with an ADD Block Ack (ADDBA) response that provides station parameters for the block acknowledgement. Similarly, the stations 120 may send an ADDBA request to the AP 110, and in response, receive an ADDBA response from the AP 110 to enable the stations 120 to transmit A-MPDUs to the AP 110 and to receive a block acknowledgement from the AP 110. The ADDBA request and response frames may have parameters related to the HARQ operations described herein. For instance, these parameters may indicate whether the AP 110 and stations 120 should implement a HARQ format, a maximum number of stored code words, etc.

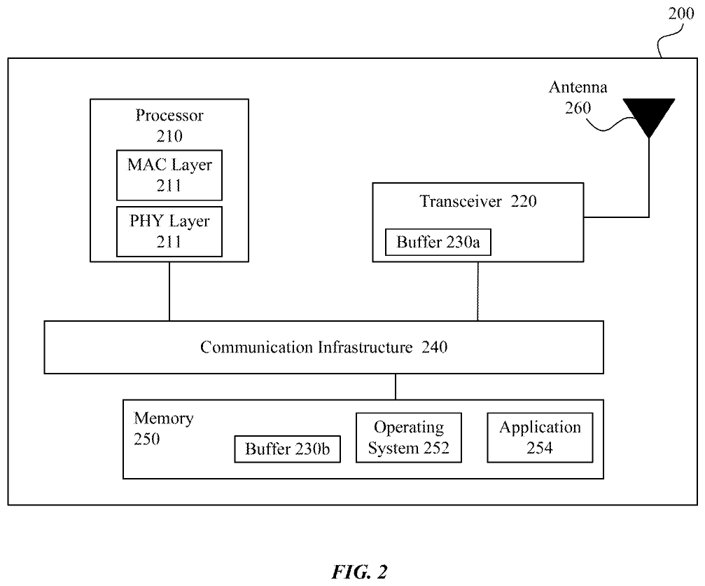

FIG. 2 illustrates a block diagram of an example wireless system 200 of an electronic device implementing the PHY-based HARQ, according to some embodiments of the disclosure. The system 200 may be any of the electronic devices (e.g., AP 110, STA 120) of system 100. The system 200 includes processor 210, transceiver 220, buffer(s) 230a and 230b, communication infrastructure 240, memory 250, operating system 252, application 254, and antenna 260. The processor 210 may further include a MAC layer 211 and PHY layer 213, as should be understood by those of ordinary skill in the arts. The MAC layer 211 and PHY layer 213 can be implemented as computer instructions stored in an internal memory of processor 210, external memory 250, or as state-machine that is “hard-wired” in processor 210. Illustrated systems are provided as exemplary parts of the system 200, and the system 200 may include other circuit(s) and subsystem(s). Also, although the systems of the system 200 are illustrated as separate components, the embodiments of this disclosure can include any combination of these, less, or more components.

The memory 250 may include random access memory (RAM) and/or cache, and may include control logic (e.g., computer software) and/or data. The memory 250 may include other storage devices or memory such as, but not limited to, a hard disk drive and/or a removable storage device/unit. According to some examples, the operating system 252 may be stored in the memory 250. The operating system 252 may manage transfer of data from the memory 250 and/or the one or more applications 254 to the processor 210 and/or the transceiver 220. In some examples, the operating system 252 may maintain one or more network protocol stacks (e.g., Internet protocol stack, cellular protocol stack, and the like) that can include a number of logical layers. At corresponding layers of the protocol stack, the operating system 252 includes a control mechanism and data structures to perform the functions associated with that layer.

According to some examples, the application 254 may be stored in the memory 250. The application 254 may include applications (e.g., user applications) used by the system 200 and/or a user of the system 200. The applications in the application 254 may include applications such as, but not limited to, Siri™, FaceTime™, radio streaming, video streaming, remote control, and/or other user applications.

Alternatively or in addition to the operating system, the system 200 may include the communication infrastructure 240. The communication infrastructure 240 may provide communication between, for example, the processor 210, the transceiver 220, and the memory 250. In some implementations, the communication infrastructure 240 may be a bus. The processor 210, e.g., the PHY layer 201b, together with instructions stored in the memory 250 may perform operations enabling the system 200 to implement the PHY-based HARQ as described herein. Additionally or alternatively, the transceiver 220 may perform operations enabling the system 200 to implement the PHY-based HARQ as described herein.

The transceiver 220 may transmit and receive communications signals that support the PHY-based HARQ, according to some embodiments, and may be coupled to the antenna 260. The antenna 260 may include one or more antennas that may be the same or different types. The transceiver 220 allows the system 200 to communicate with other devices that may be wired and/or wireless. The transceiver 220 may include processors, controllers, radios, sockets, plugs, buffers, and like circuits/devices used for connecting to and communication on networks. According to some examples, the transceiver 220 may include one or more circuits to connect to and communicate on wired and/or wireless networks. The transceiver 220 may include a cellular subsystem, a WLAN subsystem, and/or a Bluetooth™ subsystem, each including its own radio transceiver and protocol(s) as will be understood by those skilled arts based on the discussion provided herein. In some implementations, the transceiver 220 may include more or fewer systems for communicating with other devices. According to some embodiments, the processor 210, alone or in combination with the memory 250, and/or the transceiver 220, implements the PHY-based HARQ, as described herein.

Cellular subsystem (not shown) can include one or more circuits (including a cellular transceiver) for connecting to and communicating on cellular networks. The cellular networks can include, but are not limited to, 3G/4G/5G networks such as Universal Mobile Telecommunications System (UMTS), Long-Term Evolution (LTE), and the like. Bluetooth™ subsystem (not shown) can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. WLAN subsystem (not shown) can include one or more circuits (including a WLAN transceiver) to enable connection(s) and communication over WLAN networks such as, but not limited to, networks based on standards described in IEEE 802.11 (such as, but not limited to IEEE 802.11ac, IEEE 802.11ax, IEEE 802.11bc, IEEE 802.11bd, IEEE 802.11be, etc.).

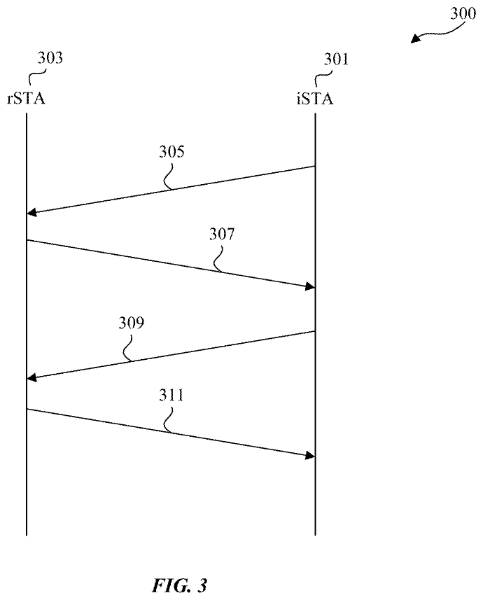

FIG. 3 illustrates example operations of communication between two electronic devices for the PHY-based HARQ, according to some embodiments of the disclosure. FIG. 3 may be described with regard to elements of FIG. 1. Operation 300 of FIG. 3 represents the communication between two electronic devices—initiating station (TSTA) 301 and responding station (rSTA) 303. According to some examples, iSTA 301 or rSTA 303 may be any one of STAs 120 and/or APs 110. The communications between the iSTA 301 and rSTA 303 may include an initial data stream 305, a feedback signal 307, a second data stream 309, and a second feedback signal 311.

In general, the data communicated between iSTA 301 and rSTA 303 in the disclosed embodiments may be conveyed in packets or frames that are transmitted and received by radios in iSTA 301 and rSTA 303 in accordance with a communication protocol, such as an Institute of Electrical and Electronics Engineers (IEEE) 802.11 standard, Bluetooth™ (from the Bluetooth Special Interest Group of Kirkland, Wash.), a cellular-telephone communication protocol, and/or another type of wireless interface (such as a peer-to-peer communication technique, a mesh-network technique, and the like). Some of the embodiments are discussed with respect to a wireless local area Network (WLAN), but the embodiments of this disclosure are not limited to use with a WLAN.

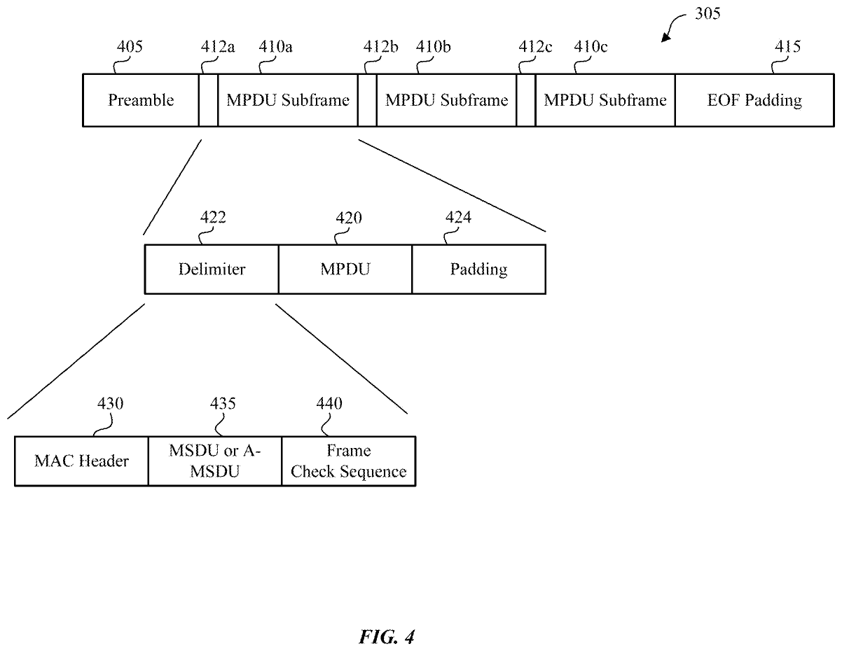

FIG. 4 illustrates an example frame format for the data stream 305, according to some embodiments of the disclosure. For example, FIG. 4 illustrates an exemplary format of physical layer convergence protocol data unit (PPDU). The PPDU may include packets and/or frames communicated between a station (e.g., STA 120a) and an access point (e.g., AP 110) or between two stations (e.g., STA 120a and STA 102b), or other packets and/or frames discussed herein, according to some examples. The PPDU include a preamble 405, one or more MAC protocol data unit (MPDU) sub-frames 410a-c (collectively referred to MPDU sub-frames 410), aggregated MPDU (A-MPDU) headers 412a-c (collectively referred to A-MPDU headers 412), and optionally, end-of-frame (EOF) padding 415. The preamble 405 may include a physical layer preamble and/or physical layer header. The preamble 405 may include information used for carrier acquisition, synchronization, channel estimation, communicating frame specific parameters (e.g., coding rate, frame length, etc.), or other purposes.

Each of the MPDU sub-frames 410 may further include an MPDU 420, and optionally, a delimiter 422 and/or padding 424. The delimiter 422 may include information on MPDU length, cyclic redundancy checks (CRC), and/or a unique pattern. The padding 424 may include additional padding (e.g., 0 to 3 bytes) to compensate for different lengths of different MPDUs.

The MPDU 420 may include a MAC header 430, a frame body (e.g., MAC service data unit (MSDU) and/or aggregated MSDU (A-MDSU)) 435, and frame check sequence (FCS) 440, according to some embodiments. The A-MSDU 435 may include one or more A-MSDU subframes, where each A-MSDU subframe can include an A-MSDU subframe header, an MSDU, and a padding, according to some embodiments. According to some examples, the packets and/or frames communicated between the STA 120a and AP 110 or between two STAs 120 may be encoded within one or more MPDUs 420.

In some examples MAC header 430 can include fields such as, but not limited to, frame control, duration field, address(es) (e.g., one or more source addresses, one or more destination addresses, etc.), sequence control, quality of service (QoS) control field, and HT control as understood by a person of ordinary skill in art. The QoS control field may include a field indicating the traffic identifier (TID). In a non-limiting example, the TID field may include four bits. The TID can indicate the stream of frames to which MSDU 435 belongs. According to some embodiments, an electronic device (e.g., STA 120a) can transmit multiple streams of frames with different QoS requirements. The TID is used to differentiate between the multiple streams of frames. The QoS field may also include a queue size subfield indicating the buffer size (e.g., the number of bytes queued in a buffer.)

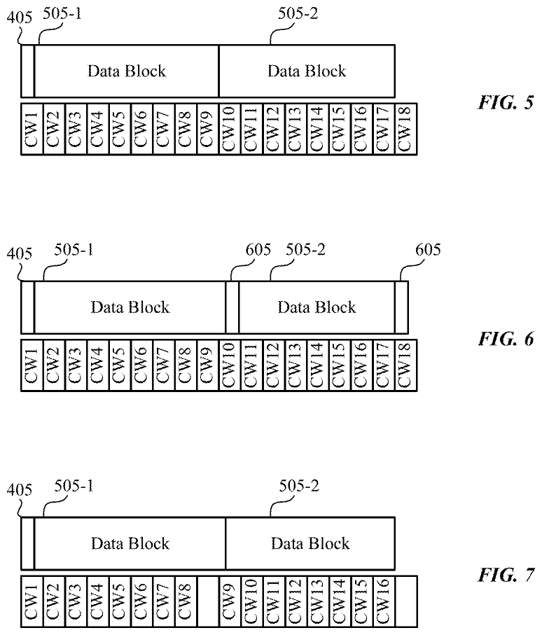

The iSTA 301 may transmit the initial data stream 305 to the rSTA 303. To achieve this, the iSTA 301 may aggregate the A-MPDU headers 412, the MPDUs 420, and/or the delimiters 422/padding 424 into data blocks 505-1, 505-2 (collectively referred to as data blocks). The iSTA 303 may generate the codewords, e.g., codewords CW 1-18, associated with the data blocks 505, as shown in FIG. 5, and checksums 605, as shown in FIG. 6. As further shown in FIG. 6, the TSTA 301 may calculate the checksums 605 and insert the checksums 605 after each data block 505. In some embodiments, the checksums 605 may be added at a defined interval, e.g., at the end of every Y CWs. The checksums 605 may be calculated based on a payload requiring N number of codewords and by using a twelve bit long cyclic redundancy check (CRC) that is calculated based on the N number of codewords. Alternatively, the iSTA 301 may calculate the checksums 605 and generate the codewords, e.g., codewords CW 1-18, associated with the data blocks 505 in parallel, and insert the checksums 605 within the codewords CW 1-8 and 9-16, as illustrated in FIG. 7. The TSTA 301 may then transit the initial data stream 305 having the data blocks 505 combined with the checksums 605, or in the alternative, the codewords CW 1-8 and 9-16 combined with the checksums 605, to the rSTA 303.

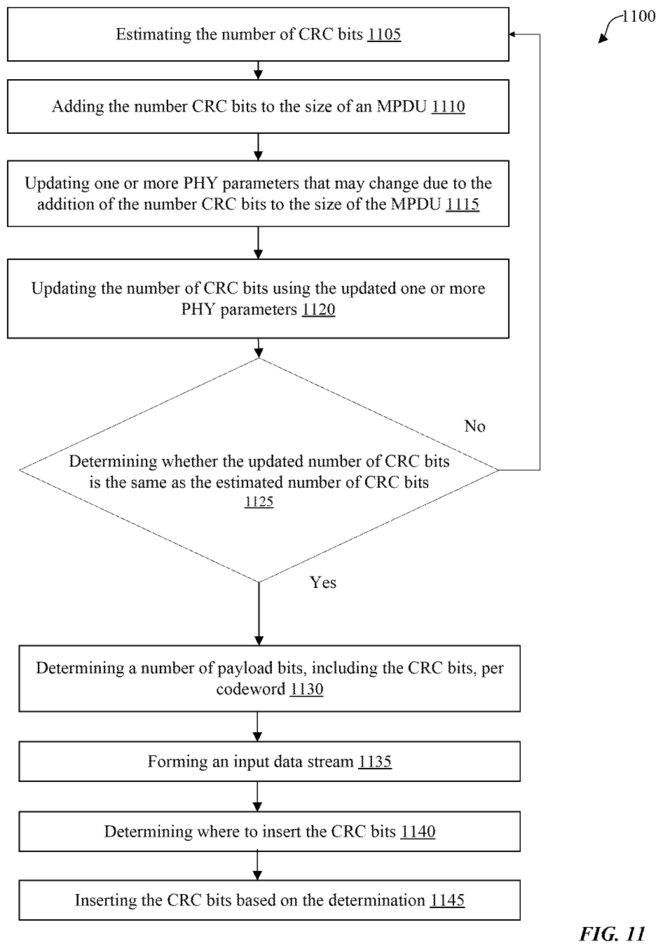

In some embodiments, the checksums 605 may be calculated by determining a lower boundary of a number CRC bits N_{CRC}, adding the number CRC bits N_{CRC} to a size of the MPDU 420, and updating the lower boundary of a number CRC bits based on one or more PHY parameters. For example, as illustrated in FIG. 11, at 1105, a method 1100 may including estimating the number of CRC bits N_{CRC} (e.g., the lower boundary of the number of CRC bits N_{CRC}). In some embodiments, the number of CRC bits N_{CRC} may be based on a length of the MPDU 420 measured in bytes N_{PSDU}, a number of bits in a service field N_{service}, a length of a codeword L_{LDPC}, a number of LDPC codewords in a codeword group N, a number of CRC bits per codeword group K, and a coding rate R. For example, in some embodiments, the number of CRC bits N_{CRC} may be determined using equation (1) illustrated below:

N_{CRC}=K·[(8·N_{PSDU}+N_{service})/(L_{LDPC}·R·N)] (1)

In some embodiments, L_{LDPC} may be a maximum length of an LDPC codeword L_{LDPCmax}, which may be used to determine the lower boundary of the number CRC bits N_{CRC}. For example, in some embodiments, L_{LDPCmax} may be 1944 bits. In some embodiments, the number of CRC bits N_{CRC} may be set to zero.

At 1110, the method 1100 may include adding the number CRC bits N_{CRC} to the size of the MPDU 420 and, at 1115, the method 1100 may include updating one or more PHY parameters that may change due to the addition of the number CRC bits N_{CRC} to the size of the MPDU 420. For example, adding the number CRC bits N_{CRC} to the size of the MPDU 420 may cause one or more PHY parameters to change based on an increase in size of the overall payload, as should be understood by those of ordinary skill in the art. For example, the one or more PHY parameters that may change include, but are not limited to, a number of Orthogonal Frequency Division Multiplexing (OFDM) symbols, a codeword length, a number of payload bits, a number of pre-FEC (forward error correction) padding bits, or a number of codewords, It should be understood by those of ordinary skill in the art that these are merely examples of PHY parameters that may change based on the number CRC bits N_{CRC} added to the MPDU 420, and that other PHY parameters are further contemplated in accordance with aspects of the present disclosure.

At 1120, the method 1100 may including updating the number of CRC bits NCRC using the updated one or more PHY parameters using equation (1). At 1125, the method 1100 may include determining whether the updated number of CRC bits N_{CRC} is the same as the estimated number of CRC bits N_{CRC} determined at 1105. In some embodiments, when the updated number of CRC bits N_{CRC} is different than the estimated number of CRC bits N_{CRC} determined at 1105, the method 1100 may include iteratively repeating 1105, 1110, 1115, and 1120 until the updated number of CRC bits N_{CRC} is the same as the estimated number of CRC bits N_{CRC} determined at 1105.

At 1130, after determining the number of CRC bits and corresponding one or more PHY parameters, the method 1100 may include determining a number of payload bits, including the CRC bits, per codeword. The number of payload bits per codeword may be represented as N_{dpcw}, with N_{dpcw} being a minimum of number of payload bits N_{pld} divided by a total number of codewords N_{cw}. That is, in some embodiments, the payload bits may be equally distributed among the total number of codewords, with N_{dpcw} payload bits in a N_{cw,th} codeword and N_{dpcw} plus 1 payload bits in (Ncw−N_{cw,th}) codewords.

At 1135, the method 1100 may include forming an input data stream. The input data stream may include a service field, a data field, and pre-FEC padding fields.

At 1140, the method 1100 may include determining where to insert the CRC bits. In some embodiments, for codeword groups having N_{dpcw} payload bits in all codewords, e.g., an index of a last codeword in the codeword group satisfies Idxₗₐₛₜ≤N_{cw,th}, the K CRC bits may be inserted for every (N_{dpcw}·N−K) bits of the input bit stream. In some embodiments, for codeword groups with a combination of codewords with N_{dpcw} payload bits and codewords with N_{dpcw} plus 1 payload bits, i.e., an index of a first and a last codeword in the group satisfying Idx_{first}≤N_{cw,th} and Idxₗₐₛₜ>N_{cw,th}, respectively, the K CRC bits may be inserted after next (N_{dpcw}·N−K+Idxₗₐₛₜ−N_{cw,th}) bits of the input bit steam. In some embodiments, for codeword groups with all of the codewords having N_{dpcw} plus 1 payload bits, i.e., the index of the first codeword in the group satisfying Idx_{first}>N_{CW,th}, the K CRC bits may be inserted for following every ((N_{dpcw}+1)·N−K) bits of the input stream. In some embodiments, the last codeword group may have less number of LDCP codewords, and as such, the K CRC bits may be appended to the end of a final codeword in a codeword group, e.g., at an end of the input data stream. At 1145, the method 1100 may include inserting the CRC bits based on the determination. In this way, the method 1100 may determine where to insert the CRC bits based on how many codewords of the codeword group are codewords having N_{dpcw} payload bits and how many codewords are codewords having N_{dpcw} plus 1 payload bits.

In some embodiments, the iSTA 301 may include a checksum field in the preamble to indicate a number of codewords for each checksum 605. For example, the checksum field may be a two digit value included in the preamble, e.g., preamble 405. A first checksum field value may indicate that no checksums 605 are included in the data stream 305, a second checksum field value may indicate that a default number of checksums 605 are included in the data stream 305, a third checksum field value may indicate that twice the number of default checksums 605 are included in the data stream 305, and a fourth checksum field value may indicate that four times the number of default checksums 605 are included in the data stream 305. It should be understood by those of ordinary skill in the art that these are merely examples and that other checksum field values are further contemplated in accordance with aspects of the present disclosure. The number of codewords per checksum 605 may be based on a transmission rate of the data stream 305 or based on combination of other transmission parameters, such as a modulation scheme, a coding scheme, a number of spatial streams, and/or a size of the transmission bandwidth. By using the checksum field, both the iSTA 301 and the rSTA 303 may be aware of the number of checksums in the data stream 305. Additionally, the TSTA 301 may use the checksum field to control an amount of overhead and retransmission unit sizes. Furthermore, the data stream 305 may include an add block acknowledge (ADDBA) request indicating a scheme for the TID that defines a feedback frame type accepted by the iSTA 301.

In response to receiving the data stream 305, the rSTA 303 may regenerate the transmitted data based on the codewords CW 1-18, i.e., generate the data blocks 505 and checksums 605. Using the PHY layer 213, the rSTA 303 may remove the checksums 605 from in between the data blocks 505 and forward the data blocks 505 to the MAC layer 211. In turn, the MAC layer 211 may parse the data blocks 505 to determine whether any transmission failures occurred with respect to any of the MPDUs 420. Alternatively, the rSTA may receive the combined codewords CW 1-8 and 9-16 and checksums 605, and the PHY layer 213 may remove the checksums 605 from the codewords CW 1-8 and 9-16. The PHY layer 213 may regenerate the data blocks 505 and forward the data blocks 505 to the MAC layer 111, which may then parse the data blocks to determine whether any transmission failures occurred with respect to any of the MPDUs 420.

In some embodiments, the PHY layer 213 may be configured to know a location of the checksums 605 in the data stream 305. Using information from the data stream 305, the PHY layer 213 in rSTA 303 may calculate expected checksums and compare the expected checksums to a respective received checksum 605. When the expected checksum value and the respective received checksum 605 do not match, the PHY layer 213 may store any codewords that carried the data associated (e.g., in data block 505) with the respective received checksum 605 in a memory, e.g., memory 250 of FIG. 2, until the codeword(s) are retransmitted. However, when the calculated and received checksums do match, the PHY layer 213 may not store any codewords in the memory. The PHY layer 213 may also store a value of a status of the comparison of the expected checksum and received checksum 605. For example, the PHY layer 213 may store a first value e.g., “1,” when the expected checksum and received checksum 605 match, and a second value, e.g., “0,” when the expected checksum and received checksum 605 do not match. In some embodiments, the PHY layer 213 may determine whether the calculated checksums and received checksums 605 match prior to the data blocks being forwarded to the MAC layer 211. In such instances, the PHY layer 213 may also indicate to the MAC layer 211 whether the calculated checksums and received checksums 605 matched.

The MAC layer 211 may parse the data blocks 505 to into the A-MPDU headers 410 and MPDUs 420. For each MPDU 420, the MAC layer 211 may check whether a received FCS matches a calculated FCS. When the received FCS and calculated FCS match, the MAC layer 211 may forward the MPDUs 420 to one or more upper layers and mark the MPDUs 420 as being received correctly. However, if the received FCS and calculated FCS do not match, the MAC layer 211 may store any codewords associated with a given MPDU, even though the PHY layer 213 may have indicated that such data was received without any transmission errors. That is, in some instances, the MAC layer 211 and the PHY layer 213 may come to different determinations about whether the data stream 305 was transmitted without any transmission errors.

Differing transmission error determinations may be the result of the checksum 605 having a transmission error or an MPDU 420 using a portion of a codeword having a transmission error outside the portion used by the MPDU 420. Using FIG. 6 as an example, the PHY layer 213 may determine that codewords CW 1-9 were correctly transmitted and codewords CW 10-18 had a transmission error. However, the MAC layer 211 may determine that the data block 505-2, which was carried by codewords 10-17, was correctly received, and as such, the MAC layer 211 may resolve any discrepancies between any codewords identified by the PHY layer 213 as requiring retransmission and that the MAC layer 211 identified as being properly received. For example, using the example above, the MAC layer 211 may determine that the codeword CW 18 had a transmission error. In this way, the rSTA 303 may indicate that codeword CW 18 requires retransmission. In some embodiments, both the iSTA 301 and the rSTA 303 may be configured to filter any codewords from a retransmission that carry data that was correctly received by the rSTA 303. In the event that only one of the TSTA 301 and the rSTA 303 is configured to filter the codewords, then all failed codewords may be retransmitted in the second data stream 309.

The rSTA 303 may transmit a feedback signal 307 to the TSTA 301 indicating whether there were any transmission errors in the data stream 305. For example, based on the ADDBA request, the feedback signal may include: a HARQ acknowledge (ACK) and/or a HARQ negative acknowledgement (NACK) to respectively indicate the codewords which were properly received and which codewords failed reception, thus requiring retransmission; a block acknowledgement to indicate the MPDUs 420 that were received without any transmission errors, such that the TSTA 301 may determine which codewords need to be retransmitted; or a combination of the block acknowledgement and a HARQ bitmap to indicate which MPDUs 420 were received without any transmission errors and any codewords that need to be retransmitted. In some embodiments, the feedback 307 may include the HARQ bitmap without any other information. Using FIG. 5 as an example, the feedback signal 307 may include a block acknowledgement indicating that reception of the data block 505-2 and its respective MPDU failed, however the HARQ bitmap may indicate that codewords CW 10-18 were correctly received. In this case, the iSTA 301 may retransmit codeword CW 18. Thus, the combination of the block acknowledgement and the HARQ bitmap may reduce the number of codewords to be retransmitted. In some embodiments, the MAC layer 211 may determine which data blocks 505 (i.e., which MPDUs 420) failed transmission and the PHY layer 213 may determine which codewords failed.

In some embodiments, the HARQ bitmap map may contain a plurality of bits indicating which codewords were successfully transmitted from the iSTA 301 to the rSTA 303. In some embodiments, each bit may correspond to a respective one of the checksums 605. For example, a first bit of the plurality of bits may indicate a successful transmission of a first set of codewords corresponding to a first checksum, the second bit of the plurality of bits may indicate a successful transmission of a second set of codewords corresponding to a second checksum, and so on and so forth. To indicate the successful transmission, a bit (e.g., the first bit) may be set to 1 if the received checksum 605 matched with the expected checksum. Otherwise, the bit may be set to 0. The bitmap may be any 2^{th} size. For example, the bitmap size may be 64, 256, or 1024 bits depending on the number of checksums 605. In some embodiments, when the data stream 305 includes less checksums than the number of bits in the bitmap, the remaining bits in HARQ bitmap have value 0.

In response to receiving the feedback 307, the iSTA 301 may analyze the feedback 307 to determine which codewords are to be retransmitted to the rSTA 301. For example, if the feedback 307 includes the combination of the block acknowledgement and the HARQ bitmap, the iSTA 301 may retransmit the codewords that are indicated as failed in both the block acknowledgment and in the HARQ bitmap. Thus, in some embodiments, when the feedback 307 includes the block acknowledgement and HARQ bitmap, the retransmitted codewords may not contain a full set codewords and their checksum. Using this information, the iSTA 301 may send a second data stream 309 to the rSTA with the codewords that are indicated as failed in both the block acknowledgment and in the HARQ bitmap.

Alternatively, if the feedback 307 includes the HARQ NACK, the iSTA 301 may transmit the second data stream 309 to include a block of failed codewords and the checksum(s). In this way, the rSTA 303 may analyze the second data stream 309 to detect whether the codewords in the retransmission are received correctly. In the event that the second data stream 309 includes less than the full set of codewords, the PHY layer 213 may soft combine the received codewords with the retransmitted codewords and pass the combination to the MAC layer 211. Using this information, the rSTA 303 may determine whether the soft combined codewords were received correctly. Furthermore, in response to receiving the HARQ NACK, the iSTA 301 may transmit the codewords with a same checksum as the data stream 305. That is, that there is no new checksum added to the retransmitted codewords.

In some embodiments, the second data stream 309 may include information based on the established HARQ format between the TSTA 301 and the rSTA 303. That is, the TSTA 301 and rSTA 303 may use the ADDBA signaling to establish the HARQ retransmission format to be used. For example, the HARQ retransmission format may use a soft combining method or an incremental redundancy method. In the soft combining method, the iSTA 301 may retransmit codewords having the same content as the originally transmitted codewords, and the rSTA 303 may combine the originally transmitted codewords with the retransmitted codewords. Furthermore, a checksum value of the retransmitted codewords may be used to determine whether the retransmitted codewords were received correctly

In the incremental redundancy method, the iSTA 301 may include additional LDPC encoding information related to the transmitted codewords, and the rSTA 303 may combine the LDCP encoding information with the previously received codewords, which results in codewords with a lower coding level, i.e., there is LDPC encoding from both the original transmission and retransmission. Additionally, with the incremental redundancy method, the PPDU preamble that carries the incremental redundancy retransmission data may contain a new LDPC coding rate, which the codewords will have after combining the LDPC encoding from the original transmission and the retransmission. Thus, the number of bits transmitted in the retransmissions may be a difference of the LDPC encoding bits in a previous LDPC code rate and the new LDPC code rate. The new LDPC encoding in the retransmitted codewords may be in the beginning of the PPDU. In some embodiments, one retransmitted codeword may contain LDPC encoding for multiple retransmitted code words, and a last codeword may contain LDPC encoding that is padded to multiple codewords, so that new data after the retransmission starts from the next codeword.

After receiving the second data stream 309, the rSTA 303 may analyze the retransmitted codewords to determine if the retransmitted were properly received, and when properly received, the rSTA 303 may combine the retransmitted codewords with the previously received data and delete the previously stored codewords from memory. Additionally, the rSTA 303 may analyze any new data using the techniques described herein. The rSTA may then transmit a second feedback 311 to the TSTA 301 using the techniques described herein.

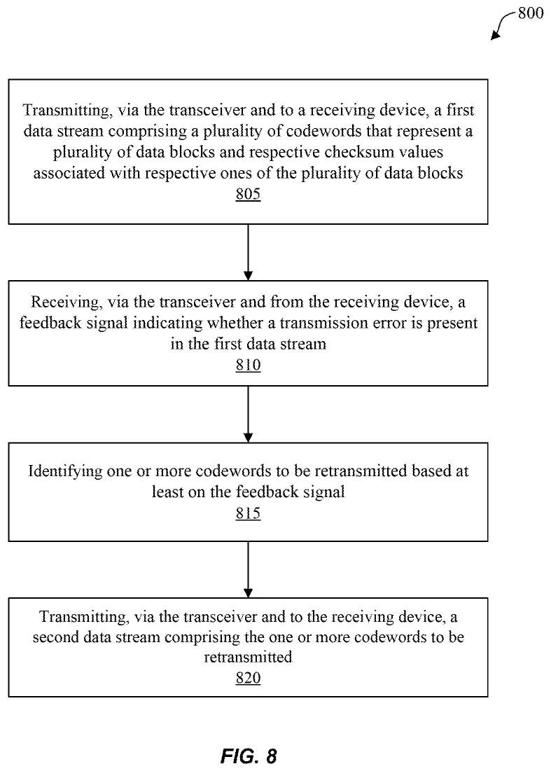

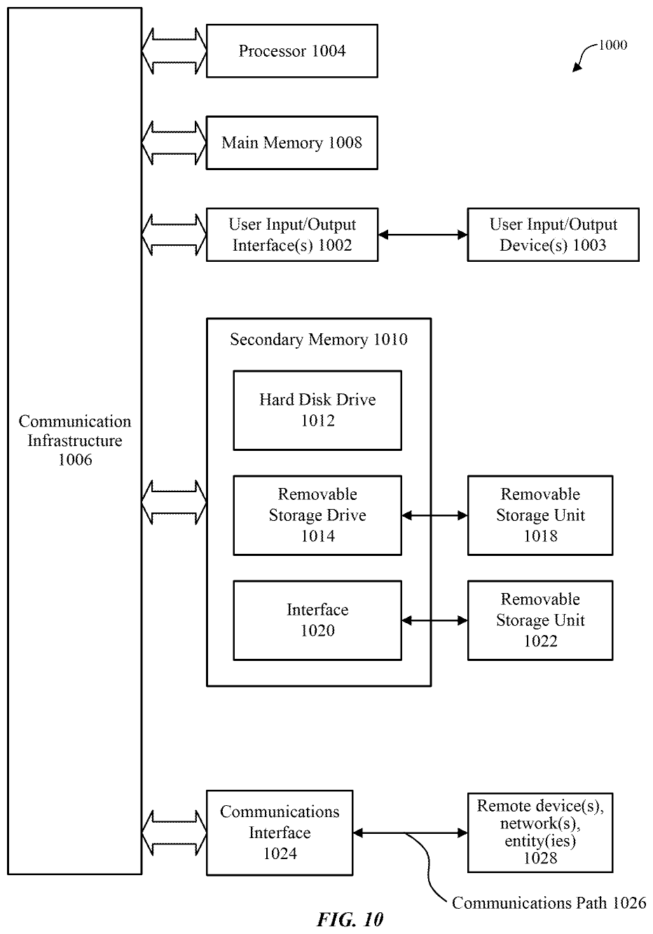

FIG. 8 illustrates an example method for implementing a PHY-based HARQ, according to some embodiments of the disclosure. A method 800 may represent the operation of a transmitting device, e.g., iSTA 301 of FIG. 3 implementing the PHY-based HARQ. The method 800 may also be performed by system 200 of FIG. 2 and/or computer system 1000 of FIG. 10. But method 800 is not limited to the specific embodiments depicted in those figures and other systems may be used to perform the method as will be understood by those skilled in the arts. It is to be appreciated that not all operations may be needed, and the operations may not be performed in the same order as shown in FIG. 8.

In 805, a transmitting device may transmit, via the transceiver and to a receiving device, a first data stream comprising a plurality of codewords that represent a plurality of data blocks and respective checksum values associated with respective ones of the plurality of data blocks. In 810, the transmitting device may receive, via the transceiver and from the receiving device, a feedback signal indicating whether a transmission error is present in the first data stream, and in 815, the transmitting device may identify one or more codewords to be retransmitted based at least on the feedback signal. In 820, the transmitting device may transmit, via the transceiver and to the receiving device, a second data stream comprising the one or more codewords to be retransmitted.

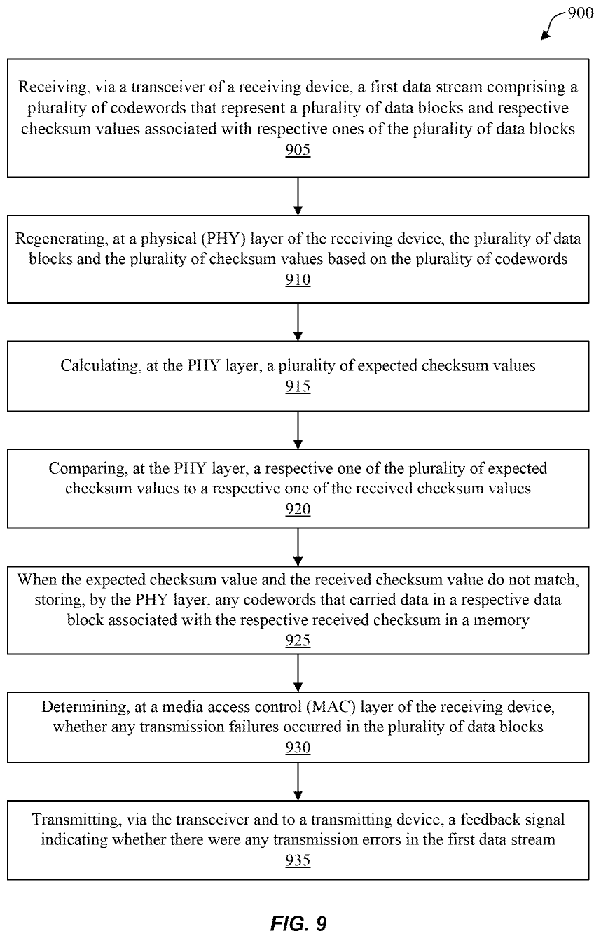

FIG. 9 illustrates an example method for implementing a PHY-based HARQ, according to some embodiments of the disclosure. A method 900 may represent the operation of a receiving device, e.g., rSTA 303 of FIG. 3 implementing the PHY-based HARQ. The method 900 may also be performed by system 200 of FIG. 2 and/or computer system 1000 of FIG. 100. But method 900 is not limited to the specific embodiments depicted in those figures and other systems may be used to perform the method as will be understood by those skilled in the arts. It is to be appreciated that not all operations may be needed, and the operations may not be performed in the same order as shown in FIG. 9.

In 905, a receiving device (e.g., rSTA 303 of FIG. 3), may receive, via a transceiver (e.g., transceiver 220 of FIG. 2), a first data stream comprising a plurality of codewords that represent a plurality of data blocks and respective checksum values associated with respective ones of the plurality of data blocks. In 910, the receiving may regenerate, at a physical (PHY) layer (e.g. PHY layer 213), the plurality of data blocks and the plurality of checksum values based on the plurality of codewords. In 915, the receiving device may calculate, at the PHY layer, a plurality of expected checksum values, and in 920, the receiving device may compare, at the PHY layer, a respective one of the plurality of expected checksum values to a respective one of the received checksum values. In 925, when the expected checksum value and the received checksum value do not match, the receiving device may also store, by the PHY layer, any codewords that carried data in a respective data block associated with the respective received checksum in a memory of the receiving device. In 930, the receiving device may determine, at a media access control (MAC) layer, whether any transmission failures occurred in the plurality of data blocks. In 935, the receiving device may transmit, via the transceiver and to a transmitting device, a feedback signal indicating whether there were any transmission errors in the first data stream.

Various embodiments can be implemented, for example, using one or more computer systems, such as computer system 1000 shown in FIG. 10. Computer system 1000 can be any well-known computer capable of performing the functions described herein such as devices 110, 120 of FIG. 1, or 200 of FIG. 2. Computer system 1000 includes one or more processors (also called central processing units, or CPUs), such as a processor 1004. Processor 1004 is connected to a communication infrastructure 1013 (e.g., a bus.) Computer system 1000 also includes user input/output device(s) 1003, such as monitors, keyboards, pointing devices, etc., that communicate with communication infrastructure 1006 through user input/output interface(s) 1002. Computer system 1000 also includes a main or primary memory 1008, such as random access memory (RAM). Main memory 1008 may include one or more levels of cache. Main memory 1008 has stored therein control logic (e.g., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018.

Removable storage unit 1018 includes a computer usable or readable storage device having stored thereon computer software (control logic) and/or data. Removable storage unit 1018 may be a floppy disk, magnetic tape, compact disk, DVD, optical storage disk, and/ any other computer data storage device. Removable storage drive 1014 reads from and/or writes to removable storage unit 1018 in a well-known manner.

According to some embodiments, secondary memory 1010 may include other means, instrumentalities or other approaches for allowing computer programs and/or other instructions and/or data to be accessed by computer system 1000. Such means, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1024. Communication interface 1024 enables computer system 1000 to communicate and interact with any combination of remote devices, remote networks, remote entities, etc. (individually and collectively referenced by reference number 1028). For example, communication interface 1024 may allow computer system 1000 to communicate with remote devices 1028 over communications path 1026, which may be wired and/or wireless, and which may include any combination of LANs, WANs, the Internet, etc. Control logic and/or data may be transmitted to and from computer system 1000 via communication path 1026.

The operations in the preceding embodiments can be implemented in a wide variety of configurations and architectures. Therefore, some or all of the operations in the preceding embodiments may be performed in hardware, in software or both. In some embodiments, a tangible, non-transitory apparatus or article of manufacture includes a tangible, non-transitory computer useable or readable medium having control logic (software) stored thereon is also referred to herein as a computer program product or program storage device. This includes, but is not limited to, computer system 1000, main memory 1008, secondary memory 1010 and removable storage units 1018 and 1022, as well as tangible articles of manufacture embodying any combination of the foregoing. Such control logic, when executed by one or more data processing devices (such as computer system 1000), causes such data processing devices to operate as described herein.

Based on the teachings contained in this disclosure, it will be apparent to persons skilled in the relevant art(s) how to make and use embodiments of the disclosure using data processing devices, computer systems and/or computer architectures other than that shown in FIG. 10. In particular, embodiments may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary embodiments of the disclosure as contemplated by the inventor(s), and thus, are not intended to limit the disclosure or the appended claims in any way.

While the disclosure has been described herein with reference to exemplary embodiments for exemplary fields and applications, it should be understood that the disclosure is not limited thereto. Other embodiments and modifications thereto are possible, and are within the scope and spirit of the disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative embodiments may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the disclosure should not be limited by any of the above-described exemplary embodiments, but should be defined only in accordance with the following claims and their equivalents.

What is claimed is:

1. A transmit device, comprising:
a transceiver configured to communicate over a wireless network; and
one or more processors communicatively coupled to the transceiver and configured to:
transmit, via the transceiver and to a receive device, a first data stream comprising a plurality of codewords that represent a plurality of data blocks and respective checksum values associated with respective ones of the plurality of data blocks;
receive, via the transceiver and from the receive device, a feedback signal indicating whether a transmission error is present in the first data stream;
identify one or more codewords to be retransmitted based at least on the feedback signal; and
transmit, via the transceiver and to the receive device, a second data stream comprising the one or more codewords to be retransmitted.

2. The transmit device of claim 1, wherein the processor is further configured to insert a respective checksum value after the respective one of the plurality of data blocks.

3. The transmit device of claim 1, wherein the processor is further configured to insert a respective checksum value in accordance with a defined interval of codewords.

4. The transmit device of claim 1, wherein the first data stream further comprises a checksum field in a preamble that indicates a number of codewords associated with the respective checksum values.

5. The transmit device of claim 4, wherein the number of codewords associated with the respective checksum values is based on a transmission rate of the first data stream.

6. The transmit device of claim 1, wherein the first data stream further comprises an add block acknowledge (ADDBA) request indicating a hybrid automatic repeat request (HARD) scheme.

7. The transmit device of claim 1, wherein the feedback signal comprises a combination of a block acknowledgement and a bitmap to indicate which data blocks were received correctly and any codewords that need to be retransmitted, and wherein the second data stream comprises codewords that are indicated as failed in both the block acknowledgment and in the bitmap.

8. The transmit device of claim 1, wherein the processor is further configured to calculate a number of the checksum value, the calculating comprising:
determining a lower boundary of a number cyclic redundancy checks (CRC) bits;
adding the lower boundary to a size of a media access control protocol data unit (MPDU); and
updating the lower boundary of a number CRC bits based on one or more physical layer parameters.

9. A receive device, comprising:
a transceiver configured to communicate over a wireless network; and
one or more processors communicatively coupled to the transceiver and configured to:
receive, via the transceiver, a first data stream comprising a plurality of codewords that represent a plurality of data blocks and respective checksum values associated with respective ones of the plurality of data blocks;
regenerate, at a physical (PHY) layer, the plurality of data blocks and the plurality of checksum values based on the plurality of codewords;
calculate, at the PHY layer, a plurality of expected checksum values;
compare, at the PHY layer, a respective one of the plurality of expected checksum values to a respective one of the received checksum values;
when the expected checksum value and the received checksum value do not match, store, by the PHY layer, any codewords that carried data in a respective data block associated with the respective received checksum value in a memory;
determine, at a media access control (MAC) layer, whether any transmission failures occurred in the plurality of data blocks; and
transmit, via the transceiver and to the transmit device, a feedback signal indicating whether there were any transmission errors in the first data stream.

10. The receive device of claim 9, wherein to determine whether any transmission failures occurred in the plurality of data blocks, the processor is further configured to:
parse the plurality of data blocks into respective aggregated MAC protocol data unit (A-MPDU) headers and respective MPDUs;
for the respective MPDUs, determine whether a received frame check sequence (FCS) matches a calculated FCS; and
when the received FCS and calculated FCS do not match, store, by the MAC layer any bitstream calculated from the codewords associated with the MPDU in the memory.

11. The receive device of claim 9, wherein the processor is further configured to, at MAC layer, resolve any discrepancies between any codewords identified by the PHY layer as requiring retransmission and that the MAC layer identified as being properly received.

12. The receive device of claim 9, wherein the feedback signal comprises a combination of a block acknowledgement and a bitmap to indicate which MAC protocol data unit (MPDUs) were received without any transmission errors and any codewords that need to be retransmitted.

13. The receive device of claim 12, wherein the bitmap comprises a plurality of bits indicating which codewords were successfully transmitted from the transmit device to the receive device.

14. The receive device of claim 9, wherein the processor is further configured to combine any retransmitted codewords in a second data stream with codewords that were correctly received in the first data stream, wherein a checksum value of the retransmitted codewords is used to determine whether the retransmitted codewords were received correctly.

15. A method comprising:
receiving, via the transceiver, a first data stream comprising a plurality of codewords that represent a plurality of data blocks and respective checksum values associated with respective ones of the plurality of data blocks;
regenerating, at a physical (PHY) layer of the receive device, the plurality of data blocks and the plurality of checksum values based on the plurality of codewords;
calculating, at the PHY layer, a plurality of expected checksum values;
comparing, at the PHY layer, a respective one of the plurality of expected checksum values to a respective one of the received checksum values;
when the expected checksum value and the received checksum value do not match, storing, by the PHY layer, any codewords that carried data in a respective data block associated with the respective received checksum value in a memory;
determining, at a media access control (MAC) layer of the receive device, whether any transmission failures occurred in the plurality of data blocks; and
transmit, via the transceiver and to a transmit device, a feedback signal indicating whether there were any transmission errors in the first data stream.

16. The method of claim 15, wherein the determining whether any transmission failures occurred in the plurality of data blocks comprises:
parsing each of the plurality of data blocks into respective aggregated MAC protocol data unit (A-MPDU) headers and MPDUs;
for each MPDU, determining whether a received frame check sequence (FCS) matches a calculated FCS; and
when the received FCS and calculated FCS do not match, storing, by the MAC layer any codewords associated with the MPDU in the memory.

17. The method of claim 15, further comprising resolving, at the MAC layer, any discrepancies between any codewords identified by the PHY layer as requiring retransmission and that the MAC layer identified as being properly received.

18. The method of claim 15, wherein the feedback signal comprises a combination of a block acknowledgement and a bitmap to indicate which MAC protocol data unit (MPDUs) were received correctly and any codewords that need to be retransmitted.

19. The method of claim 18, wherein the bitmap comprises a plurality of bits indicating which codewords were successfully transmitted from the transmit device to the receive device, wherein each bit corresponds to a respective one of the plurality of checksums.

20. The method of claim 18, wherein a first bit value indicates that a set of codewords was received correctly and a second bit value different from the first bit values indicates that the set of codewords was received with transmission errors.
